(19) United States
(12) Patent Application Publication
(10) Pub. No.: US 2026/0209505 A1
(43) Pub. Date: Jul. 23, 2026

(54) POLYMER COMPOSITION COMPRISING A THERMOPLASTIC ELASTOMER AND A HYDROCARBON PLASTICIZER RESIN

(71) Applicant: COMPAGNIE GENERALE DES ETABLISSEMENTS MICHELIN, Clermont-Ferrand (FR)

(72) Inventors: MATHILDE TOUSTOU, Clermont-Ferrand (FR); LOUIS DEBERTRAND, Clermont-Ferrand (FR)

(21) Appl. No.: 19/136,038

(22) PCT Filed: Dec. 6, 2023
(86) PCT No.: PCT/EP2023/084603

§ 371 Date: Jun. 5, 2025

(30) Foreign Application Priority Data
Dec. 8, 2022 (FR) FR2213001

(51) Int. Cl. C08L 53/02; B60C 1/00

(52) U.S. Cl. CPC C08L 53/02; B60C 1/0016; C08L 2205/06

(57) ABSTRACT

A polymer composition comprises at least one block thermoplastic elastomer of formula A-B-A, in which A is a thermoplastic block comprising α-methylstyrene units and B is a diene elastomer block predominantly comprising diene units; and at least one optionally hydrogenated hydrocarbon-based plasticizing resin having an aromatic proton content of less than or equal to 40% and a number-average molar mass (Mn) of greater than or equal to 600 g/mol. The content of hydrocarbon-based plasticizing resin is in the range from 5 to 70 phr.

### TECHNICAL FIELD

The present invention relates to a rubber composition comprising a block thermoplastic elastomer, comprising a flexible diene block and rigid thermoplastic blocks comprising α-methylstyrene units.

### PRIOR ART

Thermoplastic elastomers (TPE) are elastomers which are of great interest in many fields because of their combined properties related, on the one hand, to the flexible elastomer block and, on the other hand, to the rigid thermoplastic block. This rigid phase softens at temperatures above the glass transition temperature (Tg) or melting point (Tf) of the thermoplastic block, and regains its stiffness when the temperature falls below the Tg. This distinguishing feature of TPEs implies very wide application potential.

Among the most common thermoplastic elastomers are styrene block copolymers. The glass transition temperature of polystyrene blocks is around 80° C. to 100° C. depending on the size of the polystyrene blocks. For certain applications, the value for the glass transition temperature of polystyrene blocks is insufficient. Specifically, this value does not allow these TPEs to be used for the manufacture of certain objects that are notably subject to specific conditions of use in which the temperatures exceed 100° C. This is why it has been proposed in the past to replace polystyrene with poly-(a)-methylstyrene, whose glass transition temperature is higher than that of polystyrene, allowing better thermal resistance for the object being manufactured.

The Applicant has previously developed compositions for tyres comprising a thermoplastic elastomer. These tyres have a very good compromise of grip and rolling resistance performance.

It is known practice to use plasticizers in combination with thermoplastic elastomers in order to adjust the rigidity of the composition containing same. It is then advantageous to have plasticizers that are selective for the diene elastomer phase of the thermoplastic elastomer. Indeed, these make it possible to shift the glass transition temperature of the elastomer phase of the thermoplastic elastomer, said elastomer phase influencing the temperature positioning of the grip potential of the material, and to adjust the rigidity of the composition, without modifying the glass transition temperature of the thermoplastic phase of the thermoplastic elastomer (which controls the thermal resistance of the material, notably for high-speed performance). In WO 2020/136194 A1, the Applicant proposed using liquid polybutadienes with a specific microstructure and a number-average molar mass of more than 1500 g/mol as plasticizers to allow this selectivity.

Developers of rubber compositions for tyres are constantly looking for ways to offset the often contradictory compromises in tyre properties. Thus, it is a constant preoccupation of developers of rubber compositions for tyres to find optimized compromises in wear resistance properties and grip properties, which are contradictory properties, while at the same time ensuring good thermal resistance of the material.

### DISCLOSURE OF THE INVENTION

Continuing its efforts in this research, the Applicant has demonstrated that the combination of a triblock styrene thermoplastic elastomer, consisting of a flexible block formed from a diene elastomer and two rigid side blocks comprising α-methylstyrene units, and a specific hydrocarbon-based plasticizing resin makes it possible to obtain a selective effect of the plasticizer in the elastomer phase of the thermoplastic elastomer. This selectivity is reflected by an increase in the Tg of the elastomer phase, without modifying the Tg of the thermoplastic phase, which results in a reduction in the rigidity of the triblock without losing the material's high-temperature resistance. Specifically, this is all the more unexpected as the specific hydrocarbon-based resin used has a non-zero aromaticity content and thus is somewhat compatible with rigid styrene blocks, on which the resin finally has no significant adverse effect.

This combination of a styrene thermoplastic elastomer and a specific hydrocarbon-based plasticizing resin may advantageously be used in a rubber composition for tyres in order to improve grip with a less rigid material, without degrading the wear resistance due to the rigidity of the thermoplastic blocks being maintained, while also retaining very good thermal resistance.

Thus, a first subject of the invention is a polymer composition comprising:
at least one block thermoplastic elastomer of formula A-B-A, in which A is a thermoplastic block comprising α-methylstyrene units and B is a diene elastomer block predominantly comprising diene units,
at least one optionally hydrogenated hydrocarbon-based plasticizing resin having an aromatic proton content of less than or equal to 40%, advantageously less than or equal to 30%, and a number-average molar mass (Mn) of greater than or equal to 600 g/mol, advantageously a number-average molar mass (Mn) of less than or equal to 3000 g/mol;
the content of the hydrocarbon-based plasticizing resin is in the range from 5 to 70 phr, the maximum resin content in the composition being adapted as a function of the aromatic proton content of the resin.

A subject of the invention is also finished or semi-finished products comprising this polymer composition and intended for the manufacture of tyres, in particular, a tyre tread comprising such a composition.

A subject of the invention is also a tyre comprising such a polymer composition in all or part of its tread.

### SUMMARY OF THE INVENTION

The invention, which is described in greater detail below, has as subject at least one of the embodiments listed in the following points:

1. Polymer composition comprising:
at least one block thermoplastic elastomer of formula A-B-A, in which A is a thermoplastic block comprising α-methylstyrene units and B is a diene elastomer block predominantly comprising diene units,
at least one optionally hydrogenated hydrocarbon-based plasticizing resin having an aromatic proton content of less than or equal to 40%, advantageously less than or equal to 30%, and a number-average molar mass (Mn) of greater than or equal to 600 g/mol, advantageously a number-average molar mass (Mn) of less than or equal to 3000 g/mol,
the content of hydrocarbon-based plasticizing resin is in the range from 5 to 70 phr;
on condition that the hydrocarbon-based plasticizing resin has an aromatic proton content of greater than 15%, the resin content in the composition is at most 35 phr, and when the hydrocarbon-based plasticizing resin has an aromatic proton content of greater than 20%, then the resin content in the composition is less than 25 phr, and when the hydrocarbon-based plasticizing resin has an aromatic proton content of greater than 30%, then the resin content in the composition is less than 15 phr.

2. Composition according to embodiment 1, in which the thermoplastic blocks A predominantly comprise α-methylstyrene units.

3. Composition according to either of the preceding embodiments, in which the thermoplastic blocks A comprise styrene units.

4. Composition according to any one of the preceding embodiments, in which the thermoplastic blocks A are α-methylstyrene homopolymers (poly(α-methylstyrene)).

5. Composition according to any one of the previous embodiments, in which the thermoplastic blocks A comprising α-methylstyrene units represent at least 10% by weight relative to the weight of the thermoplastic elastomer.

6. Composition according to any one of the preceding embodiments, in which the thermoplastic blocks A comprising α-methylstyrene units represent from 10% to 45% by weight, more preferentially from 10% to 40% by weight, relative to the weight of the thermoplastic elastomer.

7. Composition according to any one of the preceding embodiments, in which the diene elastomer block B also comprises units derived from one or more styrene monomers.

8. Composition according to any one of the preceding embodiments, in which the diene elastomer block B also comprises styrene units.

9. Composition according to any one of the preceding embodiments, in which the diene units of the diene elastomer block B comprise butadiene units.

10. Composition according to any one of the preceding embodiments, in which the diene elastomer block B predominantly comprises butadiene units.

11. Composition according to any one of the preceding embodiments, in which the diene elastomer block B is a polybutadiene (BR) block.

12. Composition according to any one of the preceding embodiments, in which the block thermoplastic elastomer of formula A-B-A is a poly(α-methylstyrene)-polybutadiene-poly(a-methylstyrene) copolymer.

13. Composition according to any one of the preceding embodiments, in which said hydrocarbon-based plasticizing resin has a Tg (glass transition temperature) of greater than or equal to 30° C.

14. Composition according to any one of the preceding embodiments, in which said hydrocarbon-based plasticizing resin has a Tg (glass transition temperature) in the range from 30° C. to 150° C.

15. Composition according to any one of the preceding embodiments, in which the Mn of said hydrocarbon-based plasticizing resin is between 600 and 1500 g/mol.

16. Composition according to any one of the preceding embodiments, in which the content of said hydrocarbon-based plasticizing resin is in the range from 5 to 55 phr.

17. Composition according to any one of the preceding embodiments, in which said optionally hydrogenated hydrocarbon-based plasticizing resin
has an aromatic proton content in the range from 0 to 15%, and
is present in a content ranging from 5 to 55 phr.

18. Composition according to any one of embodiments 1 to 16, in which said optionally hydrogenated hydrocarbon-based plasticizing resin
has an aromatic proton content in the range from 0 to 20%, and
is present in a content ranging from 5 to 35 phr, preferably from 5 to 27 phr.

19. Composition according to any one of embodiments 1 to 16, in which said optionally hydrogenated hydrocarbon-based plasticizing resin
has an aromatic proton content in the range from 0 to 30%, and
is present in a content ranging from 5 phr to 20 phr, more preferably from 5 to 15 phr.

20. Composition according to any one of embodiments 1 to 16, in which said optionally hydrogenated hydrocarbon-based plasticizing resin
has an aromatic proton content in the range from 0 to 40%, and
is present in a content ranging from 5 phr to 15 phr.

21. Composition according to any one of the preceding embodiments, comprising at least one compound chosen from non-thermoplastic elastomers, reinforcing fillers chosen from carbon blacks and other organic and inorganic reinforcing fillers of siliceous type, notably silica, and also mixtures of these fillers, elastomer/filler coupling agents, non-reinforcing fillers, processing aids, stabilizers, plasticizers other than the hydrocarbon-based plasticizing resin defined in any one of the preceding embodiments, pigments, antioxidants, anti-fatigue agents, anti-ozonant waxes, adhesion promoters, reinforcing resins, crosslinking systems based on sulfur and/or peroxide and/or bismaleimides, crosslinking activators comprising zinc monoxide and stearic acid, guanidine derivatives, extender oils, silica covering agents.

22. Finished or semi-finished product intended for the manufacture of tyres comprising a composition according to any one of the preceding embodiments.

23. Tyre comprising a composition according to any one of embodiments 1 to 21 in all or part of its tread.

### Definitions

In the present document, unless expressly indicated otherwise, all the percentages (%) indicated are percentages (%) by weight.

Furthermore, any interval of values denoted by the expression “between a and b” represents the range of values inside the limits a and b (i.e. limits a and b excluded), whereas any interval of values denoted by the expression “from a to b” means the range of values extending from a up to b (i.e. including the strict limits a and b). The term “between a and b” is intended to cover the range of values denoted by the expression “from a to b”.

In the present patent application, “predominantly” or “predominant”, in connection with a compound, is understood to mean that this compound is predominant among the compounds of the same type in a composition, that is to say that it is that which represents the largest fraction by weight among the compounds of the same type. Thus, a unit resulting from a “predominant” monomer in a polymer is that representing the largest fraction by weight among the units constituting the polymer, relative to the total weight of said polymer. Alternatively, a component is “predominant” in a composition when it represents the largest fraction by weight among the components constituting the composition, relative to the total weight of said composition. In a system comprising only one element of a certain type, the latter is predominant within the meaning of the present invention.

In the present description, the term “parts per hundred parts of elastomer” or “phr” is intended to mean the part by weight of a constituent per 100 parts by weight of the elastomer(s), i.e. of the total weight of the elastomer(s), whether they are thermoplastic or non-thermoplastic, in the composition. Thus, a constituent at 60 phr will mean, for example, 60 g of this constituent per 100 g of elastomer.

Poly(α-methylstyrene) is commonly understood to mean an α-methylstyrene homopolymer.

In the present description, the term “X units” in the elastomers, whether thermoplastic or not, means units derived from the monomer X, polymerized to synthesize the elastomer. Thus, “a-methylstyrene units” are units derived from the α-methylstyrene monomer.

The compounds comprising carbon which are mentioned in the description can be of fossil or biobased origin. In the latter case, they may be partially or totally derived from biomass or may be obtained from renewable starting materials derived from biomass. In the same way, the compounds mentioned can also originate from the recycling of pre-used materials, that is to say that they can, partially or completely, result from a recycling process, or else be obtained from starting materials which themselves result from a recycling process. The monomers, the polymers, and the like, are concerned in particular.

### DETAILED DESCRIPTION OF THE INVENTION

### Thermoplastic Elastomer

The polymer composition according to the invention comprises at least one thermoplastic elastomer. The thermoplastic elastomer used for performing the invention is a block copolymer of formula A-B-A, in which A is a thermoplastic block comprising α-methylstyrene units and B is a diene elastomer block predominantly comprising diene units.

The number-average molecular mass (denoted Mn) of the TPE is preferentially between 30 000 and 500 000 g/mol, more preferentially between 40 000 and 400 000 g/mol. Below the minima indicated, there is a risk of the cohesion between the elastomer chains of the TPE being affected, in particular due to its possible dilution (in the presence of an extender oil); furthermore, there is a risk of an increase in the working temperature affecting the mechanical properties, in particular the properties at break, with the consequence of a reduced “hot” performance. Furthermore, an excessively high mass Mn can be detrimental to the processing. Thus, it has been found that a value within a range from 50 000 to 300 000 g/mol is particularly well suited, in particular to use of the TPE in a tyre composition.

For styrene TPEs, the number-average molecular mass (Mn) of the TPE elastomer is determined, in a known way, by size exclusion chromatography (SEC). For example, in the case of styrene thermoplastic elastomers, the sample is first dissolved in tetrahydrofuran to a concentration of about 1 g/l and the solution is then filtered through a filter with a porosity of 0.45 μm before injection. The apparatus used is a Waters Alliance chromatographic line. The elution solvent is tetrahydrofuran, the flow rate is 0.7 ml/min, the temperature of the system is 35° C. and the analysis time is 90 min. A set of four Waters columns in series, with the Styragel trade names (HMW7, HMW6E and two HT6Es), is used. The injected volume of the solution of the polymer sample is 100 μl. The detector is a Waters 2410 differential refractometer and its associated software, for processing the chromatographic data, is the Waters Millennium system. The calculated average molar masses are relative to a calibration curve produced with polystyrene standards. The conditions can be adjusted by those skilled in the art.

The value of the polydispersity index PI (reminder: PI=Mw/Mn, with Mw the weight-average molecular mass and Mn the number-average molecular mass) of the TPE is preferably less than 3, more preferentially less than 2 and more preferentially still less than 1.5.

In a known manner, TPEs have two glass transition temperature peaks (Tg, measured according to ASTM D3418), the lowest temperature relating to the elastomer part of the TPE and the highest temperature relating to the thermoplastic part of the TPE. Thus, the flexible blocks of the TPEs are defined by a Tg which is less than ambient temperature (25° C.), while the rigid blocks have a Tg of greater than 100° C.

In the present patent application, when reference is made to the glass transition temperature (Tg) of the TPE, it concerns the Tg relating to the elastomer block. A Tg value above these values may reduce the performance of the composition during use at very low temperature.

In order to be both elastomeric and thermoplastic in nature, the TPE has to be provided with blocks which are sufficiently incompatible (that is to say, different as a result of their respective chemical natures, of their respective polarities or of their respective Tg values) to retain their own properties of elastomer block or thermoplastic block.

TPEs that are useful for the purposes of the invention are triblock elastomers of formula A-B-A with two rigid thermoplastic segments comprising α-methylstyrene units connected by a flexible segment formed from a diene elastomer.

### Elastomer Block

The elastomer block of the TPE for the requirements of the invention can be any elastomer known to a person skilled in the art. The generally have a Tg of less than 0° C., and very preferentially less than −10° C. A Tg value above these values may reduce the performance qualities of the composition during use at very low temperature. Also preferentially, the Tg of the elastomer block of the TPE is greater than −100° C.

Diene elastomer is understood to mean an elastomer resulting, at least in part (i.e., a homopolymer or a copolymer), from diene monomers (monomers bearing two conjugated or non-conjugated carbon-carbon double bonds).

According to one embodiment of the invention, the term “diene elastomer” means any homopolymer obtained by polymerization of a conjugated diene monomer containing from 4 to 15 carbon atoms or any copolymer obtained by copolymerization of one or more conjugated dienes containing from 4 to 15 carbon atoms with each other or with one or more vinylaromatic compounds containing from 8 to 20 carbon atoms.

The following are notably suitable as conjugated dienes that may be used in accordance with the invention: 1,3-butadiene, 2-methyl-1,3-butadiene (isoprene), 2,3-bis(C₁-C₅ alkyl)-1,3-butadienes, for instance 2,3-dimethyl-1,3-butadiene, 2,3-diethyl-1,3-butadiene, 2-methyl-3-ethyl-1,3-butadiene, 2-methyl-3-isopropyl-1,3-butadiene, phenyl-1,3-butadiene, 1,3-pentadiene and 2,4-hexadiene.

Also suitable for use as conjugated dienes in accordance with the invention are linear terpenes, notably such as linear monoterpenes (C₁₀H₁₆), for example myrcene, linear sesquiterpenes (C₁₅H₂₄), for example farnesene, and the like.

According to one embodiment of the invention, the diene elastomer comprises units derived from a 1,3-diene monomer containing from 4 to 12 carbon atoms; more particularly, the diene elastomer comprises units derived from butadiene.

The following are suitable in particular as vinylaromatic compounds: styrene, α-methylstyrene, ortho-, meta- or para-methylstyrene, the “vinyltoluene” commercial mixture, para-(tert-butyl)styrene, methoxystyrenes, vinylmesitylene, divinylbenzene and vinylnaphthalene.

According to one embodiment of the invention, the diene elastomer additionally comprises units resulting from a vinylaromatic monomer, more particularly styrene.

The diene elastomer is preferentially a polybutadiene (BR), a synthetic polyisoprene (IR), a butadiene copolymer, in particular a copolymer of butadiene and of a vinylaromatic monomer, notably styrene, or an isoprene copolymer. According to one embodiment, the diene elastomer is a polybutadiene or a butadiene copolymer.

The diene elastomer can have any microstructure which depends on the polymerization conditions used.

Preferably, for the invention, the diene elastomer block of the thermoplastic elastomer exhibits, all in all, a number-average molar mass (Mₙ) of at least 25 000 g/mol, preferably of at least 35 000 g/mol, and of at most 350 000 g/mol, preferably of at most 250 000 g/mol, so as to confer, on the thermoplastic elastomers, good elastomeric properties and a satisfactory mechanical strength. The number-average molar mass of the diene elastomer block of the thermoplastic elastomer can be determined by size exclusion chromatography in a way known to a person skilled in the art using a calibration curve produced from diene standards.

### Thermoplastic Blocks

The thermoplastic elastomer according to the invention comprises two terminal thermoplastic, or rigid, blocks comprising α-methylstyrene units.

In the context of the invention, the term “thermoplastic block comprising α-methylstyrene units” means a thermoplastic block comprising units resulting from α-methylstyrene and having a glass transition temperature of greater than or equal to 100° C., preferably of at least 120° C., and of at most 200° C., advantageously ranging from 100° C. to 200° C., preferably from 120° C. to 180° C. The Tg of the thermoplastic blocks is measured according to the method described later.

Preferably, the thermoplastic blocks of the thermoplastic elastomers exhibit, all in all, a number-average molar mass (Mₙ) of at least 5000 g/mol, preferably of at least 7000 g/mol, and of at most 100 000 g/mol, preferably of at most 50 000 g/mol. The number-average molar mass of the thermoplastic block of the thermoplastic elastomer can be determined by size exclusion chromatography in a way known to a person skilled in the art and expressed here relative to polystyrene standards.

According to preferential embodiments of the invention, the thermoplastic blocks comprising a-methylstyrene units of the thermoplastic elastomer predominantly comprise units resulting from a-methylstyrene in order to impart good thermal resistance to the thermoplastic elastomer, and also to a composition containing same. In other words, according to this embodiment, each thermoplastic block preferably comprises at least 50% by weight, preferably at least 70% by weight, of units resulting from the α-methylstyrene monomer.

When the thermoplastic blocks comprising α-methylstyrene units of the thermoplastic elastomer additionally comprise units resulting from at least one other monomer, the latter can be vinylaromatic, preferably styrene. These units resulting from another monomer may also be conjugated dienes.

According to particularly advantageous embodiments, the thermoplastic blocks of the thermoplastic elastomer are essentially constituted of α-methylstyrene units, i.e. the thermoplastic blocks do not comprise units resulting from a monomer other than α-methylstyrene. Thus, better thermal resistance at higher temperature of the thermoplastic elastomer, and also of the composition containing same, is observed.

The minimum content of thermoplastic blocks in the thermoplastic elastomers can vary as a function of the conditions of use of the thermoplastic elastomers.

On the other hand, the ability of the thermoplastic elastomers to deform during the manufacture of an object can also contribute to determining the proportion of the thermoplastic blocks in the thermoplastic elastomers that may be used according to the invention.

According to certain embodiments of the invention, the thermoplastic blocks comprising a-methylstyrene units represent at least 10% by weight, preferably from 10% to 45% by weight and more preferentially from 10% to 40% by weight relative to the weight of the thermoplastic elastomer.

In the context of the invention, the polymer composition may comprise one or more thermoplastic elastomers containing at least one diene elastomer block and at least one thermoplastic block comprising α-methylstyrene units.

According to preferential embodiments, the TPE is a triblock thermoplastic elastomer which includes two poly(α-methylstyrene) thermoplastic side blocks and a central diene block, the diene being in particular a homopolymer of a 1,3-diene or a copolymer of a 1,3-diene, the 1,3-diene being as defined above and in particular isoprene or butadiene, preferably butadiene.

### Synthesis

The thermoplastic elastomer in accordance with the invention can be manufactured in a known manner according to various synthetic methods described in the prior art.

One synthetic method consists, for example, in anionically polymerizing α-methylstyrene in order simultaneously to form the two thermoplastic blocks in the presence of polydienyldilithium as polymerization initiator. For example, WO 8505116 A1 and EP 0 014 947 A1 describe such methods which comprise the copolymerization of styrene and of α-methylstyrene to generate thermoplastic blocks. A triblock copolymer of poly(α-methylstyrene-co-styrene)-b-polydiene-b-poly(a-methylstyrene-co-styrene) type is thus obtained. Analogous synthetic methods may be envisaged to manufacture poly(α-methylstyrene)-b-polydiene-poly(α-methylstyrene) triblock polymers using a polydienyllithium as polymerization initiator. Such a process is described, for example, in FR 3 045 615.

Another synthetic method consists in anionically polymerizing α-methylstyrene in a first stage. Then, in a second stage, the diene monomer is polymerized on the living poly(α-methylstyrene) chains obtained. A poly(α-methylstyrene)-b-polydiene diblock polymer, the dienyl end of which is living, is thus obtained. To obtain a triblock thermoplastic elastomer, a coupling agent is added at this stage to couple the dienyl blocks of the chains. This stage is performed in a manner known per se. The coupling agents generally contain a silicon or tin atom, substituted with two groups which are reactive with respect to the carbanion end of the living polymer chains. Examples of coupling agents that may be mentioned include dihalotin compounds and dihalosilane compounds, notably dibutyltin dichloride or dimethyldichlorosilane, or also dialkoxysilanes. The polymer resulting from the coupling step is a poly(α-methylstyrene)-b-polydiene-b-poly(α-methylstyrene) triblock.

Such synthetic processes are described, for example, in U.S. Pat. No. 4,302,559 A. The synthesis of the block copolymer comprises a first step of polymerization of α-methylstyrene at low temperature in the presence of a polar agent. In a second step, a small amount of conjugated diene is added so as to obtain a living polydienyl block to avoid the depolymerization of the α-methylstyrene. In a third step, in the presence of another polar compound, the addition of conjugated diene monomer makes it possible to insert the residual α-methylstyrene randomly. To obtain a triblock copolymer, the polymer resulting from the last polymerization step is coupled using a coupling agent. The central diene elastomer block of the triblock copolymer is, according to this method of synthesis, a random poly(butadiene-co-α-methylstyrene) copolymer.

Other processes employing this method of synthesis of a poly(α-methylstyrene)-b-polydiene-b-poly(α-methylstyrene) triblock copolymer are described, which make it possible to obtain a central diene elastomer block free of α-methylstyrene. For example, in FR 2 243 214, the process consists, in a first step, in homopolymerizing the α-methylstyrene in concentrated medium at temperatures of between 0° C. and 40° C. On conclusion of this step, the conjugated diene and the solvent that are required for the synthesis of the poly(conjugated diene) block are added. On conclusion of this last polymerization step, the polymer obtained is coupled using a coupling agent. More recently, WO 2020070406A1 describes another process for synthesizing a poly(α-methylstyrene)-b-polydiene-b-poly(α-methylstyrene) triblock copolymer, the central diene elastomer block of which is also free of α-methylstyrene.

A person skilled in the art will understand that, depending on the method and the conditions for synthesizing the thermoplastic elastomer, the product obtained may consist, besides the A-B-A (thermoplastic comprising α-methylstyrene units)-b-diene elastomer-b-(thermoplastic comprising a-methylstyrene units) triblock, of other populations of macromolecules, such as thermoplastic polymers comprising α-methylstyrene units, diene elastomers or (thermoplastic comprising a-methylstyrene units)-b-diene elastomer diblock polymers. Thus, in the context of the invention, a person skilled in the art will understand that the synthetic product comprises all of these populations when the triblock elastomer is not isolated on conclusion of its synthesis. This is why the synthetic product may comprise a diblock polymer formed from a thermoplastic block comprising a-methylstyrene units and a diene elastomer block. Generally then, the synthetic product comprises not more than 20% by weight of a diblock polymer consisting of a thermoplastic block comprising a-methylstyrene units and a diene elastomer block. Similarly, the synthetic product may comprise a thermoplastic polymer comprising α-methylstyrene units.

### Hydrocarbon-Based Plasticizing Resin

The Applicant has discovered, surprisingly, that among the hydrocarbon-based plasticizing resins, the resins in accordance with the invention used in combination with the thermoplastic elastomer as described previously surprisingly allowed the Tg of the thermoplastic polymer to be increased by significantly increasing the Tg of the diene elastomer flexible block, without significantly modifying the Tg of the thermoplastic block. Very advantageously, the change in Tg of the thermoplastic block does not exceed 10° C. This attests to a selective action by the resin on the flexible block of the thermoplastic elastomer with a view to reducing the rigidity of the thermoplastic elastomer without thereby penalizing the thermal resistance of the material.

The compositions of the invention comprise an optionally hydrogenated hydrocarbon-based plasticizing resin having a Tg (glass transition temperature) greater than or equal to 40° C., having an aromatic proton content less than or equal to 40, advantageously less than or equal to 30, and a number-average molar mass (Mn) greater than or equal to 600 g/mol.

In a manner known to those skilled in the art, the term “resin” is reserved in the present patent application, by definition, for a compound which is, on the one hand, solid at room temperature (23° C.) (as opposed to a liquid plasticizing compound such as an oil) and, on the other hand, compatible (i.e. miscible at the content used, typically greater than 5 phr) with the thermoplastic elastomer with which it is mixed.

Such a hydrocarbon-based plasticizing resin is chosen, for example, from cyclopentadiene (abbreviated to CPD) homopolymer or copolymer resins, dicyclopentadiene (abbreviated to DCPD) homopolymer or copolymer resins, terpene homopolymer or copolymer resins, C5 cut homopolymer or copolymer resins, C9 cut homopolymer or copolymer resins, and the mixtures of these resins. Among the above copolymer resins, mention may be made more particularly of those chosen from the group consisting of (D)CPD/vinylaromatic copolymer resins, (D)CPD/terpene copolymer resins, terpene/phenol copolymer resins, (D)CPD/C5 cut copolymer resins, (D)CPD/C9 cut copolymer resins, terpene/vinylaromatic copolymer resins, C5 cut/vinylaromatic copolymer resins and mixtures of these resins.

The term “terpene” groups together here, in a known manner, a-pinene, P-pinene and limonene monomers. Examples of vinylaromatic monomers that are suitable for use include styrene, a-methylstyrene, ortho-methylstyrene, metα-methylstyrene, para-methylstyrene, vinyltoluene, para(tert-butyl)styrene, methoxystyrenes, chlorostyrenes, hydroxystyrenes, vinylmesitylene, divinylbenzene, vinylnaphthalene or any vinylaromatic monomer derived from a C9 cut (or more generally from a C8 to C10 cut).

In particular, mention may be made of resins chosen from the group consisting of terpene homopolymer or copolymer resins, C5 cut/C9 cut copolymer resins, and mixtures thereof.

The hydrocarbon-based plasticizing resin that is useful for the purposes of the invention may be optionally hydrogenated.

The content of aromatic protons in the optionally hydrogenated hydrocarbon-based plasticizing resin according to the invention is less than or equal to 40%, advantageously less than or equal to 30%, preferably from 0 to 40%, more preferably from 0 to 30%. According to certain embodiments, the content of aromatic protons in the optionally hydrogenated hydrocarbon-based plasticizing resin is in the range from 0 to 20%. According to certain embodiments, the content of aromatic protons in the optionally hydrogenated hydrocarbon-based plasticizing resin is in the range from 0 to 15%, preferably in the range from 0 to 10%.

The optionally hydrogenated hydrocarbon-based plasticizing resins are obtained via processes that are well known to those skilled in the art, for instance by thermal polymerization (i.e. without a polymerization catalyst).

The optionally hydrogenated hydrocarbon-based plasticizing resin according to the invention has a number-average molar mass (Mn) of greater than or equal to 600 g/mol. Preferably, the optionally hydrogenated hydrocarbon-based plasticizing resin has a number-average molecular mass Mn in the range from 600 to 3000 g/mol, preferably from 600 to 1500 g/mol. Beyond this value the performance of the resin in admixture with the TPE is degraded and consequently the compatibility with the flexible block of the TPE is poorer.

Preferably, the optionally hydrogenated hydrocarbon-based plasticizing resin has a polydispersity index PI of less than or equal to 2, preferably less than or equal to 1.8, preferably less than 1.7.

Preferably, the optionally hydrogenated hydrocarbon-based plasticizing resin according to the invention has a glass transition temperature Tg of greater than or equal to 30° C., preferably in the range from 30° C. to 150° C., and even more preferably in the range from 40° C. to 150° C.

According to certain embodiments, the optionally hydrogenated hydrocarbon-based plasticizing resin according to the invention has a Tg in the range from 30° C. to 150° C., and also a number-average molecular mass Mn in the range from 600 to 3000 g/mol and an aromatic proton content in the range from 0 to 40%. According to certain embodiments, the optionally hydrogenated hydrocarbon-based plasticizing resin according to the invention has a Tg in the range from 30° C. to 150° C., and also a number-average molecular mass Mn in the range from 600 to 1500 g/mol, and an aromatic proton content in the range from 0 to 30%.

According to certain embodiments, the content of optionally hydrogenated hydrocarbon-based plasticizing resin is in the range from 5 phr to 70 phr, preferentially from 5 to 55 phr. Specifically, below 5 phr of the hydrocarbon-based plasticizing resin that is useful for the purposes of the invention, the effect of the resin would not be sufficient and the thermoplastic elastomer might have a Tg shift that is too low, while above 70 phr, the composition might have losses of fracture properties and losses of elasticity.

According to certain advantageous embodiments of the invention, when the optionally hydrogenated hydrocarbon-based plasticizing resin has an aromatic proton content in the range from 0 to 15%, the content of this hydrocarbon-based resin is in the range from 5 to 70 phr, preferably from 5 to 55 phr.

According to other advantageous embodiments of the invention, when the optionally hydrogenated hydrocarbon-based plasticizing resin has an aromatic proton content in the range from 0 to 20%, the content of this hydrocarbon-based resin is in the range from 5 phr to less than 45 phr, preferably from 5 to 35 phr, even more preferably from 5 to 27 phr. According to other equally advantageous embodiments of the invention, when the optionally hydrogenated hydrocarbon-based plasticizing resin has an aromatic proton content ranging from 0 to 30%, the content of this hydrocarbon-based resin ranges from 5 phr to less than 25 phr, preferably from 5 phr to 20 phr, and even more preferably from 5 to 15 phr.

According to other equally advantageous embodiments of the invention, when the optionally hydrogenated hydrocarbon-based plasticizing resin has an aromatic proton content in the range from 0 to 40%, the content of this hydrocarbon-based resin is in the range from 5 phr to less than 15 phr.

In other words,
when the hydrocarbon-based plasticizing resin has an aromatic proton content of greater than 15%, then the resin content in the composition is less than 45 phr, advantageously not more than 35 phr, more advantageously not more than 27 phr. The resin content in the composition is at least 5 phr.
when the hydrocarbon-based plasticizing resin has an aromatic proton content of greater than 20%, then the resin content in the composition is less than 25 phr, advantageously not more than 20 phr, more advantageously not more than 15 phr. The resin content in the composition is at least 5 phr.
when the hydrocarbon-based plasticizing resin has an aromatic proton content of greater than 30%, then the resin content in the composition is less than 15 phr.

According to these embodiments, the impact on the Tg of the elastomer block is significant for a surprisingly low impact on the Tg of the thermoplastic blocks.

The glass transition temperature, the macrostructure (Mn, Mw, PI) and the content of aromatic protons of the optionally hydrogenated hydrocarbon-based plasticizing resin are determined according to the methods described below in the section devoted to the examples.

The optionally hydrogenated hydrocarbon-based plasticizing resins in accordance with the invention are commercially available under the references A125 and S135 from DRT, under the reference NevChem 140 from Neville Chemical, under the references Piccotac 8090 and Piccotac 9095 from Eastmann, under the reference Sylvatraxx 6720 from Kraton, under the reference Novarez TK100 from Rain Carbon, etc.

The table below summarizes the features of the commercial resins in accordance with the invention mentioned above.

| | | | Tg Résine | % aromatic | Mn |
|---|---|---|---|---|---|
| Resin name | Supplier | Nature | (° C.) | H | (g/mol) |
| A125 | DRT | Terpene (alpha- | 84 | 1 | 810 |
| | | pinene) | | | |
| NevChem 140 | Neville | C5/C9 | 86 | 16 | 830 |
| | Chemical | | | | |
| Piccotac 8090 | Eastmann | C5/C9 | 44 | 8 | 850 |
| Piccotac 9095 | Eastmann | C5 | 42 | 2 | 1071 |
| S135 | DRT | Terpene (β-pinene) | 85 | 0 | 1245 |
| Sylvatraxx | Kraton | Terpene/phenol | 67 | 27 | 881 |
| 6720 | | | | | |
| Novarez TK100 | Rain Carbon | C9/C10 | 54 | 37 | 828 |

As already mentioned previously, the combination of the thermoplastic elastomer and the specific hydrocarbon-based plasticizing resin described above can advantageously be used within a rubber composition comprising one or more other components for the manufacture of objects that are subject to specific conditions of use where the temperatures exceed 100° C. Such a combination thus allows use in many fields to be envisaged. Mention may notably be made of use in the manufacture of various finished or semi-finished rubber-based products such as pipes, belts, vehicle tyres, shoe soles, surgical articles, etc. or semi-finished products for these products.

Such a finished or semi-finished product is also a subject of the invention. In particular, in view of the particular properties of the polymer composition of the invention, said composition is particularly suitable for use in manufacturing a finished or semi-finished product intended for tyres, especially treads, with a view notably to improving the grip properties while at the same time ensuring good thermal resistance of the material, for example for high-speed performance.

Such a composition is also a subject of the present invention.

The composition according to the invention may comprise one or more other components usually used in the intended applications.

Thus, in the context of an application in the field of tyres, the polymer composition according to the invention may also comprise one or more non-thermoplastic elastomers, such as the diene elastomers well known to those skilled in the art.

Diene elastomer should be understood, according to the invention, as meaning any synthetic elastomer resulting, at least in part, from diene monomers. More particularly, diene elastomer is intended to mean any homopolymer obtained by polymerization of a conjugated diene monomer having from 4 to 15 carbon atoms or any copolymer obtained by copolymerization of one or more conjugated dienes with one another or with one or more vinylaromatic compounds having from 8 to 20 carbon atoms.

The following are especially suitable as conjugated dienes that can be used in the process in accordance with the invention: 1,3-butadiene, 2-methyl-1,3-butadiene, 2,3-di(C₁ to C₅ alkyl)-1,3-butadienes, such as, for example, 2,3-dimethyl-1,3-butadiene, 2,3-diethyl-1,3-butadiene, 2-methyl-3-ethyl-1,3-butadiene or 2-methyl-3-isopropyl-1,3-butadiene, phenyl-1,3-butadiene, 1,3-pentadiene or 2,4-hexadiene, etc.

Also suitable for use as conjugated dienes in the process in accordance with the invention are linear terpenes, notably such as linear monoterpenes (C₁₀H₁₆), for example myrcene, linear sesquiterpenes (C₁₅H₂₄), for example farnesene, etc.

The diene elastomer that may be present in the composition is preferentially chosen from the group of diene elastomers consisting of polybutadienes (BRs), synthetic polyisoprenes (IRs), natural rubber (NRs), butadiene copolymers, isoprene copolymers, copolymers of ethylene and of diene, and mixtures of these polymers. Such copolymers are more preferentially selected from the group consisting of butadiene/styrene copolymers (SBRs), isoprene/butadiene copolymers (BIRs), isoprene/styrene copolymers (SIRs), isoprene/butadiene/styrene copolymers (SBIRs), halogenated or non-halogenated butyl rubbers, and copolymers of ethylene and of butadiene (EBRs).

According to certain embodiments of the invention, the polymer composition comprises the thermoplastic elastomer as the predominant elastomer, and the composition then preferably comprises at least 50 phr of the thermoplastic elastomer, more preferably at least 70 phr.

According to other embodiments of the invention, the polymer composition is essentially formed from the thermoplastic elastomer as elastomer. In other words, the rubber composition comprises 100 phr of the thermoplastic elastomer.

In a preferred manner, the thermoplastic elastomer(s) that may be used according to the invention and that are described previously are predominant, and most particularly are the only elastomers in the polymer composition for use in tyres.

The composition according to the invention may comprise one or more additives customarily present in rubber compositions intended notably for vehicle tyres. By way of customary additives, mention may be made, for example, of reinforcing fillers chosen from carbon blacks and other organic and inorganic reinforcing fillers of the siliceous type, notably silica, and also mixtures of these fillers, rubber/filler coupling agents, non-reinforcing fillers, processing aids, stabilizers, plasticizers other than the hydrocarbon-based plasticizing resin described above, pigments, antioxidants, anti-fatigue agents, anti-ozonant waxes, adhesion promoters, reinforcing resins, crosslinking systems based either on sulfur and/or peroxide and/or bismaleimides, crosslinking activators comprising zinc monoxide and stearic acid, guanidine derivatives, extender oils, silica covering agents.

The abovementioned features of the present invention, and also others, will be understood more clearly on reading the following description of several exemplary embodiments of the invention, which are given as non-limiting illustrations.

### EXEMPLARY EMBODIMENTS OF THE INVENTION

### 1 Tests and Measurements

### A—Method for Measuring the Glass Transition Temperature Tg of the Resins

All the glass transition temperature Tg values are measured in a known manner by DSC (Differential Scanning Calorimetry) according to the standard ASTM D3418, 1999.

### B—Measurement of the Mn of the Hydrocarbon-Based Plasticizing Resins

The macrostructure (Mw, Mn, PI and Mz) of the hydrocarbon-based resin is determined by size exclusion chromatography (SEC) on the basis of the standards ISO 16014 (Determination of average molecular mass and molecular mass distribution of polymers using size exclusion chromatography), ASTM D5296 (Molecular Weight Averages and molecular weight distribution of polystyrene by High performance size exclusion chromatography) and DIN 55672 (size exclusion chromatography).

For these measurements, the resin sample is dissolved in antioxidant-free tetrahydrofuran up to a concentration of 1.5 g/l. The solution is filtered with a Teflon filter with a porosity of 0.45 μm, using for example a disposable syringe fitted with a filter. A volume of 100 μl is injected through a set of size exclusion chromatography columns. The mobile phase is eluted at a flow rate of 1 ml/min. The columns are thermostatically maintained at 35° C. in an oven. Detection is performed by a refractometer thermostatically maintained at 35° C. The stationary phase of the columns is based on a polystyrene/divinylbenzene gel having a controlled porosity. The polymer chains are separated according to the volume that they occupy when they are dissolved in the solvent: the larger the volume they occupy, the less the pores of the columns are accessible to them and the shorter their elution time.

A Moore calibration curve connecting the logarithm of the molar mass (logM) to the elution time (et) is produced beforehand with polystyrene standards and modelled by a third degree polynomial:

$$log ( molar mass of polystyrene ) = a + b et + c et 2 + d et 3.$$

For the calibration curve, polystyrene standards with narrow molecular distributions are used (polydispersity index, PI, of less than or equal to 1.1). The range of molar masses of these standards extends from 160 to about 70 000 g/mol. These standards may be grouped together in “families” of 4 or 5 standards having a logM increment of about 0.55 between each family.

Use may be made of certified (ISO 13885 and DIN 55672) standard kits, for instance the kits of vials from PSS (Polymer Standards Service, reference PSS-pskitrll-3), and also an additional PS standard with Mp=162 g/mol (Interchim, reference 178952). These kits are provided in the form of three vials each containing a family of polystyrene standards in suitable amounts:
Black vial: Mp=1220, 4850, 15 500 and 67 500 g/mol,
Blue vial: Mp=376, 3470, 10 400, 46 000 g/mol,
Yellow vial: Mp=266, 1920, 7200, 28 000 g/mol,
PS162: Mp=162 g/mol.

The number-average molar mass (Mn), the weight-average molar mass (Mw), the average mass (Mz), the peak mass (Mp) and the polydispersity (PI=Mw/Mn with Mw being the weight-average molecular mass and Mn being the number-average molecular mass) of the resin analysed are calculated from this calibration curve. This is why they are referred to as molar masses relative to a polystyrene calibration.

The equipment used for the SEC measurement is a liquid chromatography system, for example the Waters Alliance 2690 system comprising a pump, a degasser and an injector; a differential refractometer (for example the Waters 2410 refractometer), software for data acquisition and processing, for example the Waters Empower software, a column oven, for example the Waters “Column Heater Module”, and four columns mounted in series in the following order:

| | | Molar | | | | | Reference, |
|---|---|---|---|---|---|---|---|
| | | mass | | Inside | Particle | | for |
| | | range | Length | diameter | size | Trade | information |
| Number | Brand | (g/mol) | (mm) | (nm) | (μm) | name | purposes |
| Columns | Polymer | 200- | 300 | 7.5 | 5 | MIXED-D | PL1110- |
| 1 and 2 | Laboratories | 400000 | | | | | 6504 |
| Columns | Polymer | 200- | 300 | 7.5 | 3 | MIXED-E | PL1110- |
| 3 and 4 | Laboratories | 30000 | | | | | 6300 |

### C—Measurement of the Proton Content in a Resin

The aromatic proton content and the ethylenic proton content are measured by ¹H NMR. This determination is performed with respect to all of the signals detected. Thus, the results obtained are expressed as percentage of the peak area.

The samples are dissolved in deuterated chloroform (CDCl₃) in a proportion of about 10 mg of resin in about 1 mL of solvent. The spectra are acquired on a Bruker Avance 500 MHz spectrometer equipped with a Brüker 5 mm “broad band” BBO z-grad probe. The ¹H NMR experiment uses a single 30° pulse sequence and a repetition delay of 5 seconds between each acquisition. 64 accumulations are performed at ambient temperature. The chemical shifts are calibrated relative to the protonated impurity of the deuterated chloroform; δ ppm ¹H at 7.20 ppm. The ¹H NMR signals of the aromatic protons are located between 8.5 ppm and 6.2 ppm. The ethylenic protons, for their part, give rise to signals between 6.2 ppm and 4.5 ppm. Finally, the signals corresponding to the aliphatic protons are located between 4.5 ppm and 0 ppm. The areas of each category of protons are taken relative to the sum of these areas to thus give an area distribution percentage for each category of protons.

### D—Differential Scanning Calorimetry (DSC) of the Thermoplastic Elastomer:

The characterization of the Tg values of the elastomer block and of the thermoplastic blocks is performed by a DSC measurement (DSC1 instrument from Mettler Toledo). The instrument operates under a helium atmosphere. A sample of 10 to 20 mg of thermoplastic elastomer is withdrawn and deposited in a crucible conventionally used by a person skilled in the art for performing Tg measurements.

The sample is first placed under isothermal conditions at +25° C. for 2 minutes and then cooled to −150° C. at a rate of 50° C. per minute. An isotherm is then applied at −150° C. for 10 minutes. First heating then starts from −150° C. to +10° C. at a rate of 20° C. per minute, and is continued from 10° C. to 250° C. at a rate of 50° C. per minute. The sample then undergoes quenching to reach −150° C. at the maximum rate permitted by the instrument. The sample is then maintained under isothermal conditions at −150° C. for 15 minutes. Second heating then starts from −150° C. to +10° C. at a rate of 20° C. per minute (range for measuring the Tg of the elastomer part of the TPE) and continues from +10° C. to +250° C. at a rate of 50° C. per minute (range for measuring the Tg of the poly(alpha-methylstyrene) blocks). In this measurement, only the second heating is made use of.

### E—Proton Nuclear Magnetic Resonance (¹H NMR)

The determinations of the contents of the various monomer units and of their microstructures within the thermoplastic elastomer are performed by NMR analysis. The spectra are acquired on a Bruker 500 MHz spectrometer equipped with a 5 mm BBI Z-grad “broad band” probe. The quantitative ¹H NMR experiment uses a simple 30° pulse sequence and a repetition time of 5 seconds between each acquisition. The samples are dissolved in CDCl₃. The integration zones considered for quantification are the spectral signature zones of the monomer units known to those skilled in the art.

### II. Synthesis of the Polymers and Preparation of the Polymer Compositions

In the tests that follow, the following name will be adopted:

$$poly ( α - methylstyrene ) = PAMS$$

### A—Synthesis of a Poly(α-Methylstyrene)-b-Polybutadiene-b-Poly(α-Methylstyrene) Triblock Polymer:

2.464 kg of methylcyclohexane, 6.998 kg of α-methylstyrene and 0.40 mol of tetrahydrofurfuryl ethyl ether are introduced into an 80 litre reactor. After neutralization of the impurities with n-butyllithium, 0.175 mol of s-butyllithium is introduced. After 40 minutes at T=20° C., the α-methylstyrene conversion, measured by solids content, is 38%. Analysis of the polymer by size exclusion chromatography shows the presence of a single population: Mn=13 517 g/mol. The Tg of this PAMS polymer, measured by DSC, is 145° C.

At the end of these 40 minutes at 20° C., 30.4 kg of methylcyclohexane, the impurities of which have been pre-neutralized with n-butyllithium, are introduced into the reactor and 5.5 kg of butadiene are then introduced by means of a pump at a flow rate of 5 kg/h. The reaction medium is maintained at 60° C. At the end of the 60 minutes requiring the introduction of the 5.7 kg of butadiene, the butadiene conversion at the end of these 60 minutes at 20° C. is 94%.

0.084 mol of dimethyldichlorosilane is subsequently introduced into the reactor. The reaction medium is maintained at 60° C. for 12 minutes. On conclusion of this coupling step, a poly(α-methylstyrene)-b-polybutadiene-b-poly(α-methylstyrene) triblock polymer is synthesized.

The total mass content of poly(α-methylstyrene) chains in the final sample, measured by NMR, is 29%.

The DSC Tg of the flexible polybutadiene block is −56° C.

The DSC Tg of the PAMS thermoplastic block of this thermoplastic polymer is 145° C.

### B—Preparation of the Polymer Compositions:

For each composition, the polymer and resin are placed in a container with toluene in proportions of 10% by volume of polymer in toluene, and stirred for a period of 24 hours at room temperature. The solution is then placed to dry in a hood at room temperature for 12 hours, and then in a vacuum oven at 70° C. for 48 hours. The film obtained is formed into shape by pressing at a temperature of 180° C. for 10 minutes so as to obtain the test specimens required for characterization.

Tables 1 and 2 summarize the components of the polymer compositions and their respective contents.

TABLE 1

| | 1 | 2 | 3 | 4 | 5 | 6 | 7 | 8 | 9 | 10 | 11 | 12 | 13 |
|---|---|---|---|---|---|---|---|---|---|---|---|---|---|
| α-Methylstyrene- | 100 | 100 | 100 | 100 | 100 | 100 | 100 | 100 | 100 | 100 | 100 | 100 | 100 |
| butadiene-α- | | | | | | | | | | | | | |
| methylstyrene triblock | | | | | | | | | | | | | |
| polymer | | | | | | | | | | | | | |
| Su500 | 43 | | | | | | | | | | | | |
| E5340 | | 43 | | | | | | | | | | | |
| PR383 | | | 43 | | | | | | | | | | |
| E5637 | | | | 43 | | | | | | | | | |
| E5615 | | | | | 43 | | | | | | | | |
| P1504 | | | | | | 43 | | | | | | | |
| A125 | | | | | | | 43 | | | | | | |
| Novarez TK100 | | | | | | | | 43 | | | | | |
| NevChem 140 | | | | | | | | | 43 | | | | |
| Piccotac 8090 | | | | | | | | | | 43 | | | |
| Sylvatraxx 6720 | | | | | | | | | | | 43 | | |
| Piccotac 9095 | | | | | | | | | | | | 43 | |
| S135 | | | | | | | | | | | | | 43 |

TABLE 2

| | 14 | 15 | 16 | 17 | 18 | 19 | 20 | 21 |
|---|---|---|---|---|---|---|---|---|
| α-Methylstyrene-butadiene-α- | 100 | 100 | 100 | 100 | 100 | 100 | 100 | 100 |
| methylstyrene | | | | | | | | |
| triblock polymer | | | | | | | | |
| Su500 | | | | | | | | |
| E5340 | | | | | | | | |
| PR383 | | | | | | | | |
| E5637 | | | | | | | | |
| E5615 | | | | | | | | |
| P1504 | 25 | | | | | | | |
| A125 | | | | | | | | |
| Novarez TK100 | | | | | 11 | | | |
| NevChem 140 | | 25 | | | | 11 | | |
| Piccotac 8090 | | | 25 | | | | 11 | |
| Sylvatraxx 6720 | | | | | | | | 11 |
| Piccotac 9095 | | | | 25 | | | | |
| S135 | | | | | | | | |

The characteristics of the resins are presented in Table 3.

TABLE 3

| | | | Resin Tg | % | Mn |
|---|---|---|---|---|---|
| Resin name | Supplier | Nature | (° C.) | aromatic H | (g/mol) |
| Su500 | KOLON | C5 | 50 | 1 | 355 |
| E5340 | EXXON | DCPD/C9 | 86 | 0 | 457 |
| E5637 | EXXON | DCPD/C9 | 79 | 5 | 551 |
| PR383 | EXXON | DCPD/C9 | 52 | 10 | 488 |
| E5615 | EXXON | DCPD/C9 | 68 | 10 | 561 |
| P1504 | Eastmann | Aromatic | 40 | 52 | 686 |
| A125 | DRT | Terpene (alpha-pinene) | 84 | 1 | 810 |
| Novarez TK100 | Rain Carbon | C9/C10 | 54 | 37 | 828 |
| NevChem 140 | Neville Chemical | C5/C9 | 86 | 16 | 830 |
| Piccotac 8090 | Eastmann | C5/C9 | 44 | 8 | 850 |
| Sylvatraxx 6720 | Kraton | Terpene/phenol | 67 | 27 | 881 |
| Piccotac 9095 | Eastmann | C5 | 42 | 2 | 1071 |
| S135 | DRT | Terpene (β-pinene) | 85 | 0 | 1245 |

### C—Results of the Measurements Performed

The Tg values of the polybutadiene blocks and of the PAMS blocks were measured in accordance with the method described above. The results are reported in Table 4 below as a function of the resin used and of its content in the composition.

TABLE 4

| | 43 phr Resin | | 25 phr Resin | 11 phr Resin |
|---|---|---|---|---|
| | Flexible block | PAMS | PAMS | PAMS |
| Resin name | Tg shift | Tg shift | Tg shift | Tg shift |
| Su500 | 28 | −18 | −17 | −11 |
| E5340 | 39 | −21 | — | — |
| E5637 | 35 | −16 | −16 | — |
| PR383 | 32 | −22 | — | — |
| E5615 | 35 | −22 | −18 | — |
| P1504 | 4 | −54 | −42 | — |
| A125 | 40 | −1 | — | — |
| Novarez TK100 | 23 | −25 | — | 0 |
| NevChem 140 | 18 | −18 | −9 | 3 |
| Piccotac 8090 | 31 | −3 | 1 | — |
| Sylvatraxx 6720 | 25 | −38 | — | −2 |
| Piccotac 9095 | 31 | −2 | 6 | −1 |
| S135 | 49 | 6 | — | — |

It is thus found that with the hydrocarbon-based plasticizing resins having the features of an aromatic proton content of less than or equal to 40% and a number-average molar mass (Mn) of greater than or equal to 600 g/mol, it is possible, as a function of the various polymer compositions, to increase the Tg of the elastomer phase, without, however, prohibitively modifying the Tg of the thermoplastic phase.

1.-15. (canceled)

16. A polymer composition comprising:
at least one block thermoplastic elastomer of formula A-B-A, in which A is a thermoplastic block comprising α-methylstyrene units and B is a diene elastomer block predominantly comprising diene units; and
at least one optionally hydrogenated hydrocarbon-based plasticizing resin having an aromatic proton content of less than or equal to 40% and a number-average molar mass Mn of greater than or equal to 600 g/mol and less than or equal to 3000 g/mol,
wherein a content of the at least one optionally hydrogenated hydrocarbon-based plasticizing resin is in a range from 5 to 70 phr, and
wherein, when the at least one optionally hydrogenated hydrocarbon-based plasticizing resin has an aromatic proton content of greater than 15%, the at least one optionally hydrogenated hydrocarbon-based plasticizing resin content in the polymer composition is at most 35 phr, when the at least one optionally hydrogenated hydrocarbon-based plasticizing resin has an aromatic proton content of greater than 20%, then the at least one optionally hydrogenated hydrocarbon-based plasticizing resin content in the polymer composition is less than 25 phr, and when the at least one optionally hydrogenated hydrocarbon-based plasticizing resin has an aromatic proton content of greater than 30%, then the at least one optionally hydrogenated hydrocarbon-based plasticizing resin content in the polymer composition is less than 15 phr.

17. The polymer composition according to claim 16, wherein the thermoplastic block A predominantly comprises α-methylstyrene units.

18. The polymer composition according to claim 16, wherein the thermoplastic block A is a α-methylstyrene homopolymer.

19. The polymer composition according to claim 16, wherein the thermoplastic block A comprising α-methylstyrene units represents at least 10% by weight relative to a weight of the at least one block thermoplastic elastomer.

20. The polymer composition according to claim 16, wherein the diene elastomer block B further comprises units derived from one or more styrene monomers.

21. The polymer composition according to claim 16, wherein the diene elastomer block B predominantly comprises butadiene units.

22. The polymer composition according to claim 16, wherein the at least one optionally hydrogenated hydrocarbon-based plasticizing resin has a glass transition temperature Tg of greater than or equal to 30° C.

23. The polymer composition according to claim 16, wherein Mn is between 600 and 1500 g/mol.

24. The polymer composition according to claim 16, wherein the content of the at least one optionally hydrogenated hydrocarbon-based plasticizing resin is in the range from 5 to 55 phr.

25. The polymer composition according to claim 16, wherein the at least one optionally hydrogenated hydrocarbon-based plasticizing resin has an aromatic proton content in the range from 0 to 15% and is present in a content ranging from 5 to 55 phr.

26. The polymer composition according to claim 16, wherein the at least one optionally hydrogenated hydrocarbon-based plasticizing resin has an aromatic proton content in the range from 0 to 20% and is present in a content ranging from 5 to 35 phr.

27. The polymer composition according to claim 16, wherein the at least one optionally hydrogenated hydrocarbon-based plasticizing resin has an aromatic proton content in the range from 0 to 30% and is present in a content ranging from 5 phr to 20 phr.

28. The polymer composition according to claim 16, further comprising at least one compound selected from the group consisting of non-thermoplastic elastomers, reinforcing fillers, elastomer/filler coupling agents, non-reinforcing fillers, processing aids, stabilizers, plasticizers other than the at least one optionally hydrogenated hydrocarbon-based plasticizing resin, pigments, antioxidants, anti-fatigue agents, anti-ozonant waxes, adhesion promoters, reinforcing resins, crosslinking systems based on sulfur and/or peroxide and/or bismaleimides, crosslinking activators comprising zinc monoxide and stearic acid, guanidine derivatives, extender oils, and silica covering agents.

29. A finished or semi-finished product intended for the manufacture of tires comprising the polymer composition according to claim 16.

30. A tire comprising the polymer composition according to claim 16 in all or part of a tread of the tire.
